(19) United States
(12) Patent Application Publication
(10) Pub. No.: US 2024/0294069 A1
(43) Pub. Date: Sep. 5, 2024

(54) ARRANGEMENT FOR THE VISUAL DISPLAY OF INFORMATION IN THE AREA OF A WINDSCREEN OF A MOTOR VEHICLE

(71) Applicant: Dr. Ing. h.c. F. Porsche Aktiengesellschaft, Stuttgart (DE)

(72) Inventors: Christian Rommelfanger, Bad Liebenzell (DE); Philipp Bolay, Flacht (DE)

(21) Appl. No.: 18/591,143

(22) Filed: Feb. 29, 2024

(30) Foreign Application Priority Data
Mar. 1, 2023 (DE) 10 2023 105 014.1

(51) Int. Cl. B60K 35/28

(52) U.S. Cl. CPC B60K 35/28; B60K 2360/23; B60K 2360/332; B60K 2360/785

(57) ABSTRACT

An arrangement (1) is provided for a visual display of information in the area of a windscreen (2) of a motor vehicle. The windscreen (2) has at least one inner window (20) and one outer window (21). A lighting device (4) is attached to the windscreen (2), and light (8) emitted by the lighting device (4) can be coupled into the windscreen (2) at an end face. At least one optically functional area (200, 210) is configured within the inner window (20) and/or the outer window (21). The at least one optically functional area (200, 210) changes reflection properties of the light (8) coupled into the windscreen (2) as compared to other areas (201, 202, 211, 212) of the inner window (20) and/or the outer window (21).

### CROSS-REFERENCE TO RELATED APPLICATION

This application claims priority on German Patent Application No 10 2023 105 014.1 filed Mar. 1, 2023, the entire disclosure of which is incorporated herein by reference.

### BACKGROUND

### Field of the Invention

The invention relates to an arrangement for the visual display of information in the area of a windscreen of a motor vehicle.

### Related Art

In modern motor vehicles, the number of visual displays of information using light in the vehicle cockpit is increasing due to new functions and the desired interaction options with the vehicle occupants. For this purpose, a light guide can be introduced circumferentially in the front of the dashboard and is used to display so-called “welcome light functions” or “turn signal functions”. In the prior art, there is often a high potential for installation space conflicts between a head-up display and the vents of the motor vehicle.

U.S. Pat. No. 8,894,256 B2 discloses a window frame of a motor vehicle where a light source is provided on the window frame.

U.S. Pat. No. 5,465,194 relates to a motor vehicle with a rear window that has a circumferentially extending optical fiber.

The present invention has the object of providing a space-optimized arrangement for the visual display of information in the area of a windscreen of a motor vehicle.

### SUMMARY OF THE INVENTION

The invention relates to an arrangement for a visual display of information in the area of a windscreen of a motor vehicle. The windscreen has at least one inner window and an outer window. A lighting device is attached to the windscreen, such that the light emitted by the lighting device during operation can be coupled into the windscreen at an end face. At least one optically functional area is configured within the inner window and/or the outer window, and reflection properties of the light coupled into the windscreen are changed in the optically functional area with respect to other areas of the inner window and/or the outer window. The invention defines a neutral package, since the at least one optically functional area is configured integrally within the windscreen. No installation space for a separate light guide needs to be provided, thereby optimizing installation space for the arrangement. The arrangement also offers manufacturing efficiencies since no separate light guide needs to be fitted and assembled.

One embodiment attaches the lighting device to the windscreen so that the light emitted by the lighting device during operation can be coupled into the windscreen at a lower end face.

Some embodiments have light scattering contours in the at least one optically functional area. The light scattering contours can be configured to scatter the light, such that three-dimensional bodies and/or shapes can be depicted.

The light scattering contours of some embodiments are produced in a laser-lithographic fashion. Laser light enables the light scattering contours to be produced very simply and with high precision.

In one embodiment, the lighting device comprises a housing and at least one LED light source accommodated in the housing.

Some embodiments bond the housing of the lighting device to the windscreen to achieve a secure and yet easy to produce hold of the lighting device on the windscreen.

The housing of one embodiment has a substantially U-shaped cross-section and comprises two retaining legs that are configured to laterally encompass the inner window and the outer window at an area adjacent to the end face of the windscreen. This makes it easy to align the lighting device relative to the windscreen during assembly.

Further features and advantages of the invention will become apparent from the following description of a preferred embodiment with reference to the accompanying drawing.

### BRIEF DESCRIPTION OF THE DRAWING

FIG. 1 is a highly simplified sectional view of an arrangement for a visual displaying information in the area of a windscreen of a motor vehicle.

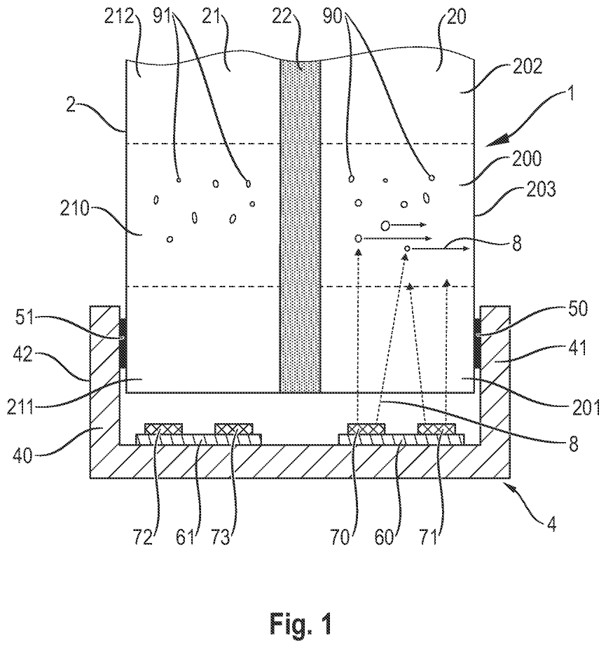

### DETAILED DESCRIPTION

An arrangement 1 is provided for visually displaying information in the area of a windscreen 2 of a motor vehicle. The windscreen 2 is made of a laminated glass and has an inner window 20 and an outer window 21. An intermediate layer 22 is arranged between the inner and outer windows 20 and 21 and has a high tear resistance and splinter binding properties. Thus, the intermediate layer 22 imparts the windscreen 2 special safety properties in the event of a breakage. For example, the intermediate layer 22 can be composed of a thermoplastic resin, such as polyvinyl butyral (PVB). Polyvinyl butyral is a hot melt adhesive that is arranged between the inner window 20 and the outer window 21 in the form of an adhesive film during the manufacture of the laminated glass windscreen 2. The laminated glass windscreen 2 is manufactured in a known manner by a lamination process in an autoclave. This ensures that the inner window 20 and the outer window 21 are connected to each other by the intermediate layer 22.

A lighting device 4 is attached to the windscreen 2 to generate light effects in the area of the windscreen 2 and also to enable visual interaction with the driver or other vehicle occupants. The lighting device 4 has a housing 40 with a substantially U-shaped cross-section and comprises two retaining legs 41, 42 that laterally encompass the inner window 20 and the outer window 21 in an area adjacent to the end face of the windscreen 2 so that the windscreen 2 is arranged between the retaining legs 41, 42. Adhesive layers 50, 51 connect the retaining legs 41, 42 to the inner and outer windows 20 and 21 respectively. Other ways of fixing the lighting device 4 to the windscreen 2 are possible.

At least one optically functional area 200 is coupled into the inner window 20 and causes the reflection properties of light 8 that is coupled into the windscreen to be changed with respect to the other areas 201, 202. The outer window 21 of this embodiment also has at least one optically functional area 210 that causes the reflection properties of the light that is coupled into the windscreen 2 to be changed with respect to the other areas 211, 212. In principle, it is possible to provide only the inner window 20 or only the outer window 21 with at least one optically functional area 200, 210. The changed light can provide a welcome illumination for the vehicle in response to unlocking of the vehicle. Alternatively, the changed light can advise the driver that a directional signal is operating, that a fuel level or state of charge of a battery is low, that a speed limit is being exceeded, that a road surface is slippery or other information.

Optically functional contours 90, 91 are produced by exposure to laser light, such as by laser lithography, in the optically functional areas 200, 210 of the inner and outer windows 20 and 21. Thus, the optically functional areas 200, 210 of the inner window 20 and the outer window 21 have altered reflection properties, and scattering of incident light 8 takes place in each case because of the lasered-in optically functional contours 90, 91. Multiple optically functional regions 200, 210 can be provided in the inner window 20 and/or the outer window 21 and can have different visual properties.

Two printed circuit boards 60, 61 are accommodated within the housing 40 of the lighting device 4 and have one or more LED light sources 70, 71, 72, 73 arranged thereon. The light 8 is emitted by the LED light sources 70, 71 during operation of the lighting device 4. The light 8 is shone into the inner window 20 in the area of a lower end face and initially is transmitted through the unprocessed area 201 of the glass. The light 8 then is scattered in the optically functional area 200 of the inner window 20, emerges from a boundary area interface 203 of the optically functional area 200 of the inner window 20 and is detected by the eye of an observer in the interior of the motor vehicle.

The multi-layered structure of the windscreen 1, in which the inner window 20 and the outer window 21 each have at least one optically functional area 200, 210 with altered reflection properties, allows a three-dimensional depth effect to be achieved in an advantageous manner. Furthermore, different display geometries are possible.

1. An arrangement (1) for a visual display of information in the area of a windscreen (2) of a motor vehicle, the windscreen (2) having an inner window (20) and an outer window (21), the arrangement comprising: a lighting device (4) attached to the windscreen (2), such that light (8) emitted by the lighting device (4) during operation is coupled into an end face of the windscreen (2), and at least one optically functional area (200, 210) is configured within at least one of the inner window (20) and the outer window (21), reflection properties of the light (8) coupled into the windscreen (2) being changed at the at least one optically functional area (200, 210) as compared to other areas (201, 202, 211, 212) of the inner window (20) and the outer window (21).

2. The arrangement (1) of claim 1, wherein the lighting device (4) is attached to the windscreen (2) at a location so that the light (8) emitted by the lighting device (4) during operation is coupled into the windscreen (2) at a lower end face.

3. The arrangement (1) of claim 1, wherein light scattering contours are configured in the at least one optically functional area (200, 210).

4. The arrangement (1) of claim 3, wherein the light scattering contours are configured and disposed to scatter the light (8) such that three-dimensional bodies and/or shapes can be displayed.

5. The arrangement (1) of claim 3, wherein the light scattering contours are laser lithographed contours.

6. The arrangement (1) of claim 1, wherein the lighting device (4) comprises a housing (40) and at least one LED light source (70, 71, 72, 73) accommodated in the housing (40).

7. The arrangement (1) of claim 6, wherein the housing (40) of the lighting device (4) is glued to the windscreen (2).

8. The arrangement (1) of claim 6, wherein the housing (40) has a substantially U-shaped cross-section and comprises two retaining legs (41, 42) that laterally encompass the inner window (20) and the outer window (21) at a region adjacent to the end face of the windscreen (2).
